(19) United States
(12) Patent Application Publication
(10) Pub. No.: US 2005/0270771 A1
(43) Pub. Date: Dec. 8, 2005

(54) Portable multi-purpose lantern

(76) Inventor: Se Kit Yuen, Hong Kong (HK)

Correspondence Address: ARTHUR KING MA, 1030 CORONADO DRIVE, ARCADIA, CA, 91007, US

(21) Appl. No.: 10/983,848

(22) Filed: Nov. 8, 2004

(30) Foreign Application Priority Data
Jun. 6, 2004 (HK) 04104875.8

(51) Int. Cl. F21L 4/02

(52) U.S. Cl. 362/184

(57) ABSTRACT

This invention involves a lantern with one hand grip and four light sources; they are old-cathode light, an SOS signal flashlight, a spot light and an illuminant. Said grip corresponds movements between position one and position two. Said grip is on the same horizontal line as said illuminant at position one to provide user with an appropriate hand grip. Said grip becomes perpendicular to the illuminant at position two to provide user with an alternative hand grip. One of the four light sources is a hi-tech super-power spotlight, which can move relatively between position one and position two and is adjustable to stay at any angle for appropriate lighting. Luminosity of one source could reach 2,500,000 candela, and the lighting distance reaches 12,000 meters. The hi-tech super-power spotlight can provide continuous light for as long as 200 hours.

### BACKGROUND OF PRESENT INVENTION

1. Field of Invention

Said present invention is relates to a lantern with one hand grip and four light sources, more particularly, it relates to an electric light with a lighting distance of 1200 meters and four light sources, a long-life cold-cathode light, a SOS signal flashlight, a spot light and a main illuminant. Said grip corresponds movements between position one and position two within 90 degree.

2. Description of Related Arts

Military, law enforcement, fire and rescue personnel, security personnel, hunters and recreational boaters among other for nighttime surveillance in any application commonly use lantern, where a high intensity spotlight is required. Nowadays, such application is highly demeaned in all anti-terrorists actions that take place at nighttime. Conditions of use are highly varied, but generally require said light to deliver a desired field of view at long distances, be reliable, durable and field maintainable in order for it to be practically used in said designed applications. Typically said light is hand carried and must be completely operable using simple and easily access manual controls, which do not require said use of two hands. In prior art xenon short-arc searchlights or illumination systems, whether handheld, portable or fixed mounted, said luminance distribution of said arc has been positioned facing in said direction of said beam (cathode to said rear), to provide a uniform beam pattern when said arc is at said focal point of said parabolic reflector. When said arc is moved slightly beyond (or slightly rearward of) said reflector's focal point, said combination of a placing all available light in said high magnification section of said reflector and collecting it in a slightly convergent manner produces roughly twice said operating range as a conventional anode-forward device.

Also, all prior arts of lanterns are focusing mainly of power sources or power supply to power up lanterns. Seldom of prior arts are aiming to improve lighting angles as most lanterns are used with handheld or placed on a table/floor or even placed with a hat. However, it is very obviously that lantern with an ability to rotate with certain degree of angles s so needed.

U.S. Pat. No. 6,685,337 provides a lantern which combine both a flashlight with a candle together to ensure said lantern can still light up when power source is done or batteries are all used up. However, said lighting range, lighting angles and said lighting power of a candle are minimal. Such lantern light up by a candle will not be said most useful tool in an event of a big area.

U.S. Pat. No. 6,629,767 discloses a lantern with a batteries compartment with shock absorber lining to protect batteries contained therein from damage due to excessive shock applied to said batteries. Again, this lantern is only aiming a power supply to said lantern but lighting range and lighting angle are being ignored.

U.S. Pat. No. 6,702,452 provides a lantern with a tripod supporting legs. Said mounting is a tripod mount so that said portable searchlight may be fixed in said field to a tripod with said second device. Said mounting on said handle is a thumbscrew mount to permit mounting of an optical detection device onto said searchlight and rigidly fixed to said housing. However, this lantern provide without no ability to move any angle to obtain a better light range.

### SUMMARY OF PRESENT INVENTION

Said main object of said present invention is to provide a lantern having a hand grip can make corresponding movements between position one and position two. Said grip is on said same horizontal line as said illuminant at position one to provide said user with an appropriate hand grip. Said grip becomes perpendicular to said illuminant at position two to provide said user with an alternative hand grip. One of said four light sources is a hi-tech super-power spotlight, which can move relatively between position one and position two and is adjustable to stay at any angle for appropriate lighting.

Another object of said present invention is to provide a lantern having a hand grip can provide an ability to rotate and/or to move any position within 90 degree circular arc.

Another object of said present invention is to provide a lantern having an ability to adopt difference power source supplies.

Another object of said present invention is to provide a lantern having a supporting means and such supporting mean can provide an adjustable mean with a tight or loose positions so as to controlling such supporting legs in a locked position or in a rotating position to reach said best lighting range and lighting angles.

Accordingly, to achieve said above objects, a lantern comprises:
a rectangular housing, inside of it contains four mean of lighting sources;
a plurality of reflector is fixed around said mean of light sources; and
a transparent front flat board;
a sealed packing collar is connecting a inner portion of said transparent front flat board and said reflector which resides inside of an annular nut, said annular nut providing a fixed position and a disassembled position on front portion of said housing. Surface of said annular nut, which is located in front of said housing, set an annular shockproof nut. It is made of rubber or other soft material to prevent said rechargeable halogen lantern from shocks or quakes when excessive external force applied to it.

### BRIEF DESCRIPTION OF SAID DRAWINGS

FIG. 1 is a side view of said present invention showing a hand grip and an illuminant in position one.

FIG. 2 is a side view of said present invention showing a hand grip and an illuminant in position two.

FIG. 3 is a sectional view thereof.

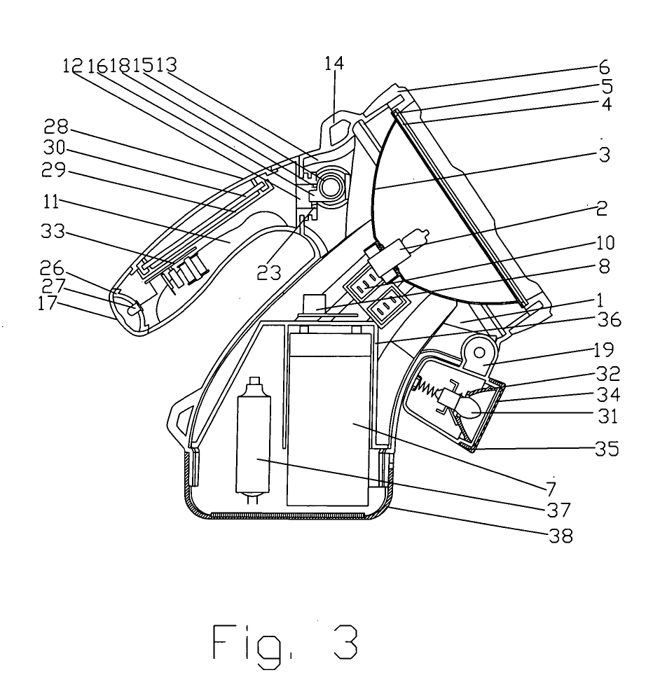

FIG. 4 is an underneath view thereof.

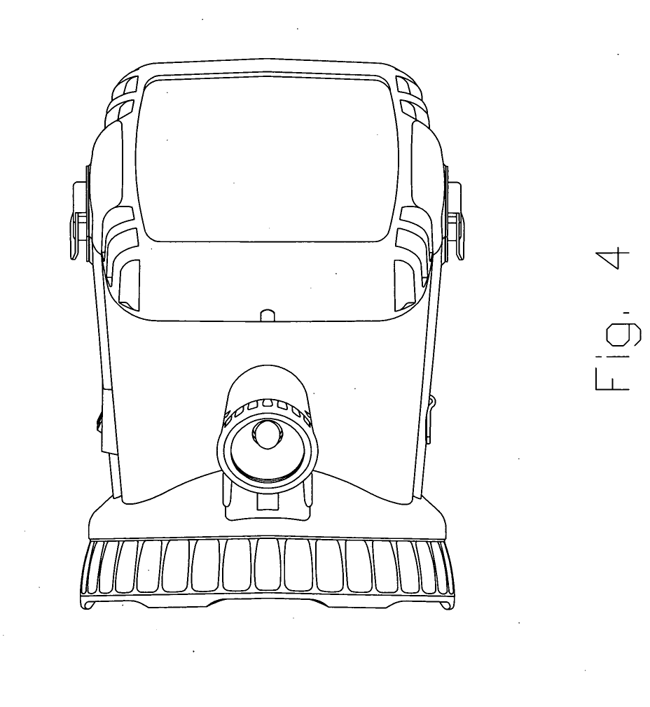

FIG. 5 is a front view thereof.

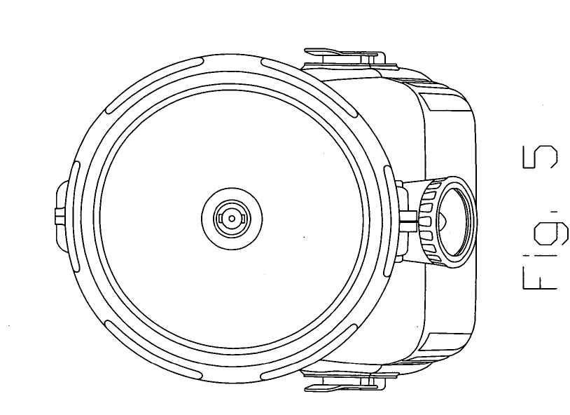

FIG. 6 is a bottom view thereof.

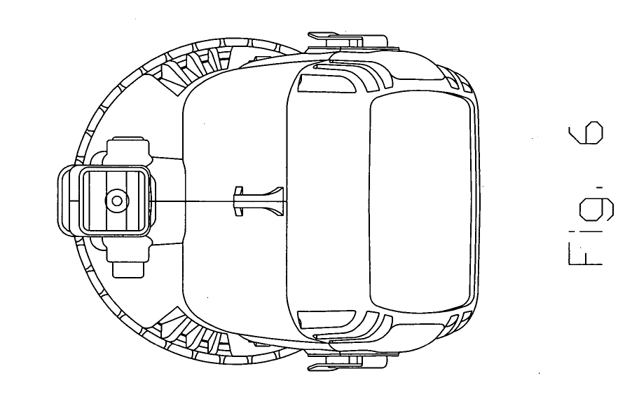

FIG. 7 is another side view thereof.

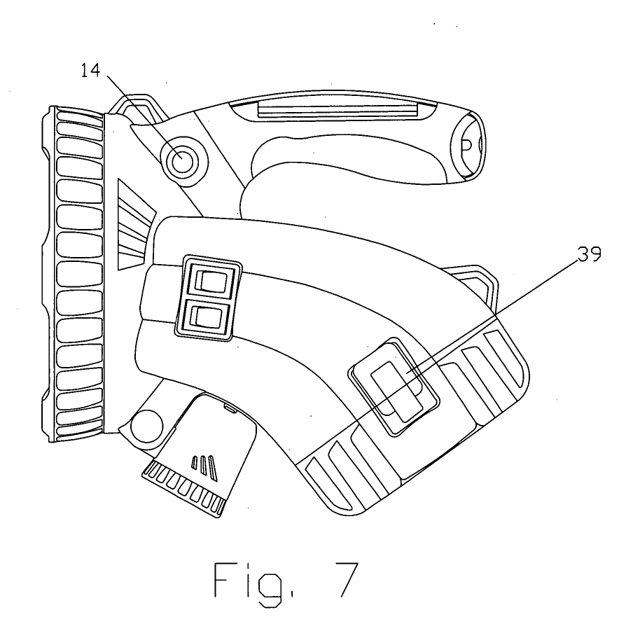

FIG. 8 is top view thereof.

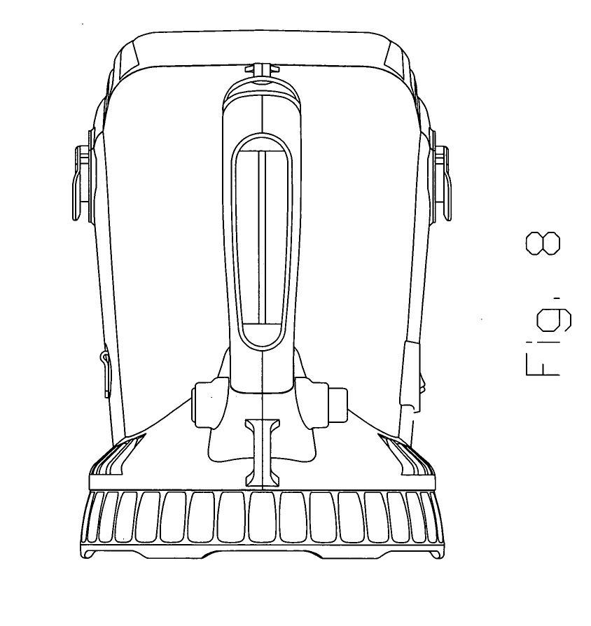

FIG. 9 is an isometric right front view with a hand grip in closing position thereof.

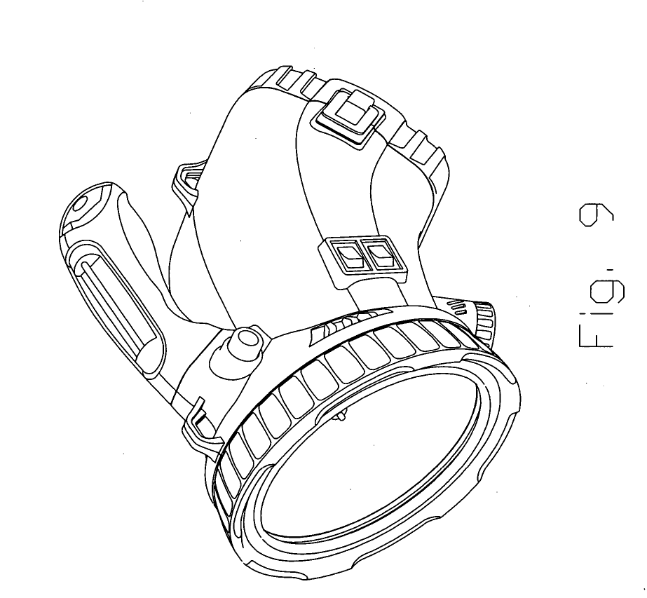

FIG. 10 is an isometric left side view thereof.

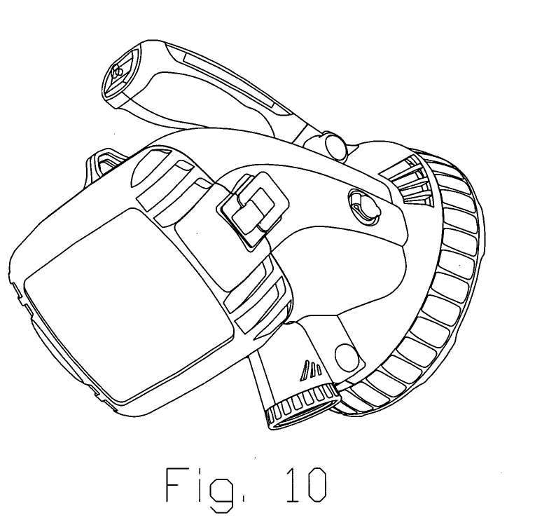

FIG. 11 is an isometric left rear view with a hand grip in an opening position thereof.

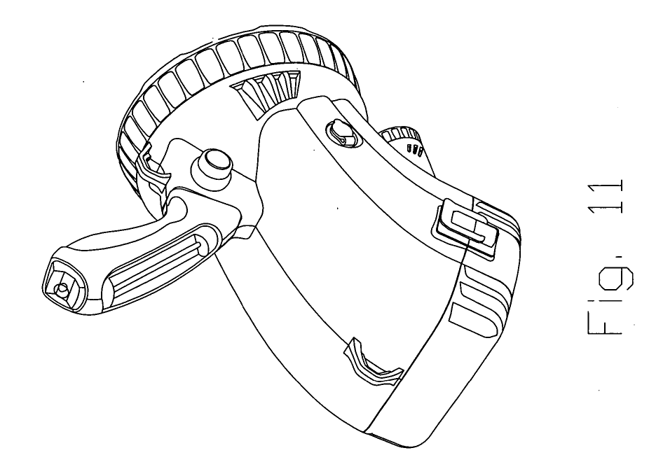

FIG. 12 is an isometric right front view with a hand grip in an opening position thereof.

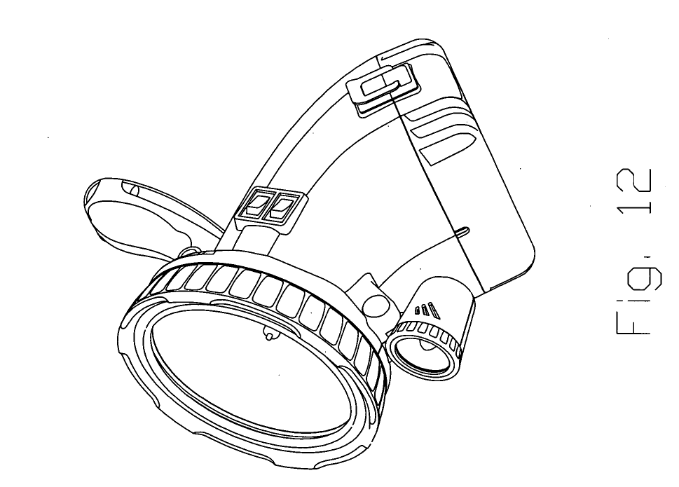

FIG. 13 is an isometric right front view with a hand grip in an opening position and an assembly view of SOS light source thereof.

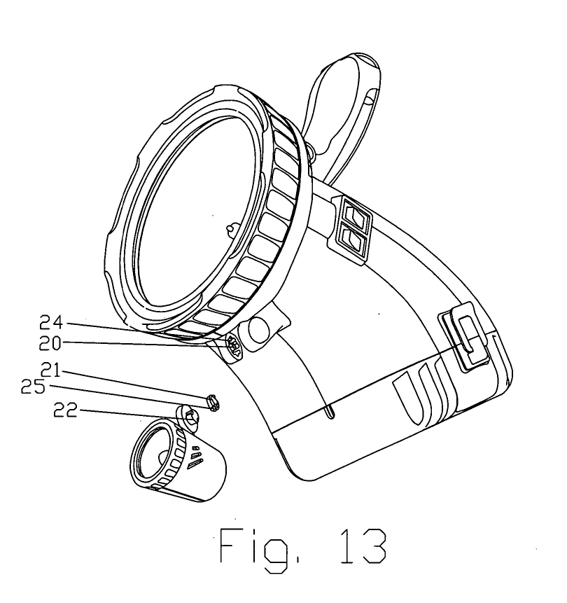

### DETAILED DESCRIPTION OF SAID PREFERRED EMBODIMENT

This invention comprises of a rectangular cylinder illuminant (1), wherein a first light source (2) is installed, a usually parabola-shaped reflector (3) and a front panel (4) made of glass or other transparent materials. A sealing washer (5) seals up said inner side of said front panel (4) with a surface of said reflector (3) within said front annular head (6). Said annular head (6) may be fastened to said front end of said illuminant (1) in a dismantling manner.

As indicated in said pictures, said first light source (2) includes a bulb powered by said power source (7) inside said illuminant, which is connected to said circuit device (8) in said illuminant (1) via a power cord. Said socket (9) and said switch (10) are connected to said bulb. It is obvious that said light source (2) may also be powered by ordinary or rechargeable battery. Said power source (7) is affixed on said battery cell box (36) at said bottom of said illuminant (1) in a movable fashion. Said external power supply (37) may also be stored in said battery cell box (36). Said bottom of said battery cell box (36) is sealed by said chassis (38). Said chassis (38) may be fastened to said front bottom of said illuminant (1) in a dismantling manner, and fastened by said snap-ring (39) made of metal or plastic material on said left and/or right side of said illuminant (1), to affix said chassis (38) to said bottom of said illuminant (1).

Said hand grip (11) is fastened to said illuminant (1) in a movable manner. Said hand grip (11) is a rectangular cylinder structure, fastened to said housing washer flange (13) of said illuminant (1) via a cylinder-shaped joint axle (12) in a moveable manner. there is a rectangular cylinder switch button (14) inside said housing washer flange (13) of said illuminant (1), and a slingshot (15) inside said switch (11). Said housing washer flange (13) on said illuminant (1) is permanently affixed to said illuminant (1).

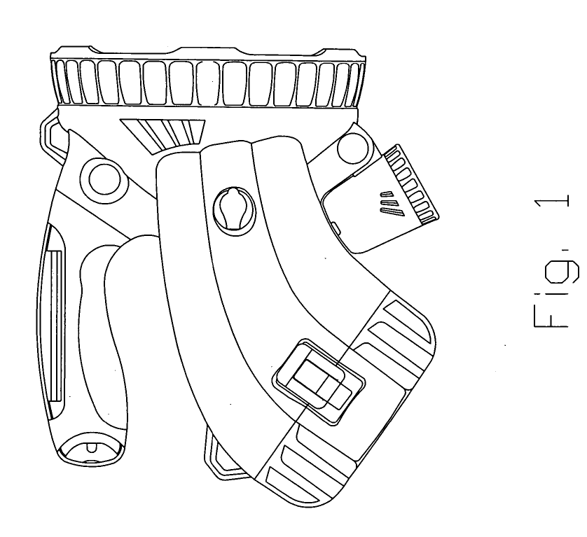

In this invention, said hand grip (11) can make relative movement between position one and position two in contrast with said illuminant itself. As indicated in FIG. 1, said pivoted arm (16) of said switch hand grip (14) is inserted into said elongated slot (18) of said joint axle (12) at one side of said hand grip (11), so that said connective axle (12) on that side of said hand grip (11) cannot move freely. Thus said hand grip (11) has to stay at position one. When said switch hand grip (14) receives outside pressure, said pivoted arm (16) of said switch hand grip (14) will be pushed into said annular hole (23) in said central of said elongated slot (18) in said joint axle (12) on one side of said hand grip (11), then said joint axle (12) on that side of said hand grip (11) can move freely, and said hand grip (11) can move from position one to position two. Meanwhile, when said outside pressure disappears, said slingshot (15) within said switch hand grip (14) will push said switch (14) back to said former position, and push said pivoted arm (16) on said switch hand grip (14) back to said elongated slot (18) of said joint axle (12) at said other side of said hand grip (11), so that said joint axle (17) on that side of said hand grip (11) can not make further movement but be fastened to position two.

It is obvious that said housing washer flange (13) connected to said illuminant (1) is also connected to said joint axle (12) at one side of said hand grip (11), to enable said hand grip (11) make free rotation of 360°.

At said end of said hand grip (11), there is a flash shield (17) made of transparent materials. On said rear side of said flash shield (17), there is usually a parabola-shaped reflecting cup (26), in said center of which lies said second source (27). In said upper center of said hand grip (11), there is a shade (28) made of transparent materials, next to which there is a panel (29) in said rear. Said third source (30) of long-life cold-cathode light is usually fastened to center of said top panel (29). A circuit device (33) beneath said panel (29) provides said second source (27) and said third source (30) with activated power.

Spotlight (19) may be connected to said illuminant (1) in a flexible manner. As illustrated, said movable joint coupling (20) is affixed to said bottom of said illuminant (1) and this also includes an elastic annular guide (21), which is tightly placed inside said joint axle (22) of said spotlight (19). Said joint axle (22) of said spotlight (19) and said ring-shaped guide (21) may be inserted into said gear teeth (24) of said movable joint coupling (20) in a flexible way. From said ex-circle surface of said fastening guide (21) extends at least one contacting gear (25) to combine with many gear teeth (24) to affix said spotlight (19) to a rotating position relative to said illuminant (1), and to form gear teeth (24) on said ex-circle surface of said ring-shaped guide (21) evenly. Said movable joint coupling (20) is connected to said illuminant (1) in an adjustable way and to said joint axle (22) of said spotlight (19) so as to adjust said folding angle between said illuminant (1) and said spotlight (19) in a movable way. Thus said spotlight (19) can provide said illuminant (1) with an alternative lighting angle. In said spotlight (19) there installed said fourth source (31), usually a parabola-shaped reflector (34) and a front panel (34) made of glass or other transparent materials. Said front panel (34) is sealed to said reflector (32) within said front annular head (6) from inside. Said annular head (35) may be fastened to said front of said spotlight (19) in a dismantling manner.

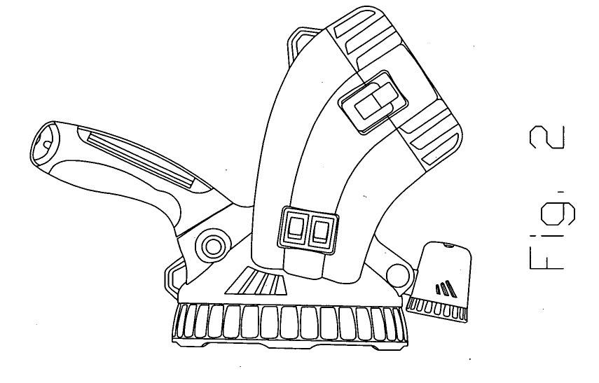

In another word, as illustrated in FIG. 1, when said hand grip (11) is in position one on said illuminant (1), this invention may be used as a portable flashlight. As illustrated in FIG. 2, when said hand grip (11) is in position two on said illuminant (1), this invention may be used as a flashlight, and is especially convenient when used to search targets or to provide multi-angle lighting. It is very useful for high-risk workers such as policemen, firemen and soldiers.

This invention has an angle-adjustable spotlight (19) at said bottom, and a long-life cold-cathode light in said center of said hand grip (11) acting as said third light source. It allows said users who cannot hold said spotlight by hand yet need sufficient light source to place this spotlight steadily on either said table or said ground provide lighting. At said end of said hand grip (11), there is a second light source (27), which provides SOS signals for said benefit of said user in said dark rural area or in need of car repair on highway.

1. A multi-purpose lantern comprises:
a rectangular housing, inside of it contains a mean of lighting source;
at least one mean of spot light source; and
at least one mean of SOS flesh light source; and
at least one mean of cold-cathode light source; and
a plurality of reflector is fixed around said mean of light source; and
a plurality of transparent front flat board; and
a plurality of seal packing collar is connecting an inner portion of said transparent front flat board and said reflector which resides inside of a plurality of annular nut. Said plurality of annular nut providing a fixed position and a disassembled position on front portion of said housing. Surface of said annular nut, which is located in front of said housing, set of plurality of annular shockproof nut. It is made of rubber or other soft material to prevent said rechargeable halogen lantern from shocks or quakes when excessive external force applied to it; and
having a supporting means and such supporting mean can provide an adjustable mean with a tight or loose positions so as to controlling such supporting legs in a locked position or in a rotating position to reach said best lighting range and lighting angles; and
having a hand grip can provide an ability to rotate and/or to move any position within 90 degree circular arc, and
said grip is on said same horizontal line as said illuminant at position one to provide said user with an appropriate hand grip. Said grip provides support for said housing in a horizontal position to get said best lighting angle, and having a handle attached to said housing providing mean of carrying.

2. A multi-purpose lantern comprises:
a rectangular housing, inside of it contains a mean of lighting source;
at least one mean of spot light source; and
at least one mean of SOS flesh light source; and
at least one mean of cold-cathode light source; and
a plurality of reflector is fixed around said mean of light source; and
a plurality of transparent front flat board; and
a plurality of seal packing collar is connecting an inner portion of said transparent front flat board and said reflector which resides inside of a plurality of annular nut. Said plurality of annular nut providing a fixed position and a disassembled position on front portion of said housing. Surface of said annular nut, which is located in front of said housing, set of plurality of annular shockproof nut. It is made of rubber or other soft material to prevent said rechargeable halogen lantern from shocks or quakes when excessive external force applied to it; and
a hand grip can provide an ability to rotate and/or to move any position within 90 degree circular arc, and
said grip is on said same horizontal line as said illuminant at position one to provide said user with an appropriate hand grip. Said grip provides support for said housing in a horizontal position to get said best lighting angle
having grip can move relatively and interactively between position one and position two allowing tightly affixed at any position to provide an adjustable lighting angle, said supporting legs provide a support on plane surface for to provide a distance lighting mean with any angle over 90°, and
said grip can also provide rotating positions through said adjustable hinge to any position within 270 degrees circular arc, and
having a grip which can move relatively and interactively between position one and position two allowing tightly affixed at any position to provide an adjustable lighting angle, said grip provide a support on plane surface for to provide a distance lighting mean with any angle over 90°, and
said grip can also provide rotating positions through said adjustable hinge to any position within 270 degrees circular arc, they provide support for said housing in
a horizontal position to get said best lighting angle, and
having a handle attached to said housing providing mean of carrying.

3. A multi-purpose lantern as recited in claim 1, wherein, said multi-purpose lantern is further comprises:
at least one light bulb,
at least one spot-light bulb,
at least one mean of cold-cathode light source, and
at least one arc shaped reflector,
at least one set of main switch,
at least one power receptacle for external electricity,
at least one transformer, and
at least one set of circuitry and power supply.

4. A multi-purpose lantern as recited in claim 1, wherein said grip is an adjustable handle providing a mean of supporting and said grip can provide an adjustable mean with a tight or loose positions so as to controlling such grip in a locked position or in a rotating position to reach said best lighting range and lighting angles through said attached hinge to any position within 270 degrees circular ark. Said stands can move relatively and interactively between position one and position two allowing tightly affixed at any position to provide an adjustable lighting angle, said grip provide a support on plane surface for to provide a distance lighting mean with any angle over 90°, Said stands provide supports for said housing.

5. A multi-purpose lantern as recited in claim 1, wherein said multi-purpose lantern is a light, further comprising: a light housing to which said arc lamp is stationary mounted; a reflector housing to which said reflector is mounted;
a reflector positioner comprising a threaded coupling between said light housing and said reflector housing enabling longitudinal displacement of said reflector relative to said light
housing by said user manipulation;
and a fluted heat sink mounted on said light housing, wherein said housing conductively dissipates lamp heat from said anode.

6. A multi-purpose lantern as recited in claim 1, wherein said multi-purpose lantern comprises four lighting sources, has an energy saving cold-cathode light source, which is located on front. Electricity is provided by a power source within said housing. Electricity current goes through power cord to said insides of electrical circuitry of said housing and transformer, while connects power receptacle, on/off switch, and links up with energy saving florescent bulb.

7. A multi-purpose lantern as recited in claim 1, wherein said multi-purpose lantern can draw electricity either from AC power outlet provided from public utility or from said chargeable battery directly.

8. A multi-purpose lantern as recited in claim 1, wherein multi-purpose lantern further comprises:
a handle in a rectangular shape is longitudinally attached to said housing. A front and rear of said handle are equipped with stripes so as to provide a mean of carrying.

9. A multi-purpose lantern as recited in claim 1, wherein said multi-purpose lantern further comprises:
a battery cover is located at rear portion of said housing. Metal screws tightly locked a battery cover to said rear bump of said housing. A seal packing collar fastens said light fixture's rear inside with a front end of said battery cover. Said battery cover provides disassembling position or a fixed position at rear portion of said housing. Batteries can be changed when said battery cover and said housing are separated. Surface of said battery cover contains a rubber or soft material made sealing nut. There is a lid on said sealing nut that can seal said entrance of said external receptacle, thus prevent water and is more durable.

10. A multi-purpose lantern as recited in claim 2, wherein said grip can provide an adjustable mean with a tight or loose positions so as to controlling such grip in a locked position or in a rotating position to reach said best lighting range and lighting angles through said attached hinge to any position within 270 degrees circular ark. Said grip can move relatively and interactively between position one and position two allowing tightly affixed at any position to provide an adjustable lighting angle, said grip provide a support on plane surface for to provide a distance lighting mean with any angle over 90°, Said stands provide supports for said housing.

11. A multi-purpose lantern as recited in claim 2, wherein said multi-purpose lantern is a light, further comprising: a light housing to which said arc lamp is stationary mounted; a reflector housing to which said reflector is mounted;
a reflector positioner comprising a threaded coupling between said light housing and said reflector housing enabling longitudinal displacement of said reflector relative to said light housing by said user manipulation;
and a fluted heat sink mounted on said light housing, wherein said housing conductively dissipates lamp heat from said anode.

12. A multi-purpose lantern as recited in claim 2, wherein said multi-purpose lantern comprises four lighting source, has an energy saving cold-cathode light source, which is located on front. Electricity is provided by a power source within said housing. Electricity current goes through power cord to said insides of electrical circuitry of said housing and transformer, while connects power receptacle, on/off switch, and links up with energy saving halogen bulb.

13. A multi-purpose lantern as recited in claim 2, wherein multi-purpose lantern can draw electricity either from AC power outlet provided from public utility or from said chargeable battery directly.

14. A multi-purpose lantern as recited in claim 1, wherein said multi-purpose lantern further comprises:
a handle in a rectangular shape is longitudinally attached to said housing. A front and rear of said handle are equipped with stripes so as to provide a mean of carrying.

15. A multi-purpose lantern as recited in claim 1, wherein said multi-purpose lantern further comprises:
a battery cover is located at rear portion of said housing. Metal screws tightly locked a battery cover to said rear bump of said housing. A seal-packing collar fastens said light fixture's rear inside with a front end of said battery cover. Said battery cover provides disassembling position or a fixed position at rear portion of said housing. Batteries can be changed when said battery cover and said housing are separated. Surface of said battery cover contains a rubber or soft material made sealing nut. There is a lid on said sealing nut that can seal said entrance of said external receptacle, thus prevent water and is more durable.
